(19) United States
(12) Patent Application Publication
(10) Pub. No.: US 2026/0074087 A1
(43) Pub. Date: Mar. 12, 2026

(54) Continuous 3D-Cooled Atom Beam Interferometer

(71) Applicant: The Government of the United States of America, as represented by the Secretary of the Navy, Arlington, VA (US)

(72) Inventors: Adam Black, Annandale, VA (US); Jonathan Kwolek, Arlington, VA (US)

(73) Assignee: The Government of the United States of America, as represented by the Secretary of the Navy, Arlington, VA (US)

(21) Appl. No.: 19/381,860

(22) Filed: Nov. 6, 2025

Related U.S. Application Data
(63) Continuation of application No. 18/066,344, filed on Dec. 15, 2022.
(60) Provisional application No. 63/290,682, filed on Dec. 17, 2021.

(51) Int. Cl. G21K 1/00; G01C 19/58; G01P 15/08; H05H 3/02

(52) U.S. Cl. CPC G21K 1/30; G01C 19/58; G01P 15/08; H05H 3/02

(57) ABSTRACT

Some embodiments of the present disclosure provide atom beam interferometry. MTL beams are directed to respective MTL regions along a 3D-cooled atom beam. Within each MTL region, the respective MTL beam coherently imparts photon recoil momenta to atoms of the atom beam to produce an interference signal in the atom beam. The MTL beams are switched between first and second cases providing first and second interfering trajectory paths for the atom beam, and the atom beam is continuously directed through the MTL regions while switching the MTL beams. Atoms from the atom beam are received along the first and second interfering trajectory paths at a detection region. State-dependent responses from the atoms of the atom beam are induced in the detection region to provide data of atomic states occupied by the atoms. The data of the atomic states is translated into an interferometry measurement. Related interferometers are also disclosed.

### CROSS-REFERENCE

This Application is a Nonprovisional patent application and claims the benefit of priority under 35 U.S.C. 120 as a continuation of U.S. patent application Ser. No. 18/066,344 filed on Dec. 15, 2022, which claims the benefit of priority under 35 U.S.C. § 119 based on U.S. Provisional Patent Application No. 63/290,682 filed on Dec. 17, 2021. The disclosures of Provisional Patent Application No. 63/290,682, patent application Ser. No. 18/066,344, and all references cited herein are hereby incorporated by reference into the present disclosure in their entirety.

### FEDERALLY-SPONSORED RESEARCH AND DEVELOPMENT

The U.S. Government has ownership rights in this invention. Licensing inquiries may be directed to Office of Technology Transfer, US Naval Research Laboratory, Code 1004, Washington, DC 20375, USA; +1.202.767.7230; nrltechtran@us.navy.mil, referencing Navy Case #210909.

### TECHNICAL FIELD

The present disclosure relates to a method and device for performing continuous, inertially sensitive atom interferometry measurements in a 3D-ultracold atomic beam, e.g., for the purpose of measuring acceleration, rotation rate, or gravity.

### BACKGROUND

Atom interferometers provide a means of measuring accelerations, rotation rates, acceleration due to gravity, or gravity gradients through the quantum mechanical interference of atomic matter waves.

One common class of atom interferometers is known as “light-pulse” atom interferometers, in which in which coherent interaction with momentum-transfer laser beams (“MTL beams”) causes the atoms to propagate in a quantum superposition of trajectories that interfere with one another. In one common MTL beam geometry, three sets of counter-propagating laser beam pairs driving momentum-changing Raman transitions, separated by a free evolution period T, produce an interferometer with inertially sensitive phase difference (to lowest order in T)

$$Φ = {T}^{2} {\vec{k}}_{eff} \cdot ( \vec{a} - 2 \vec{Ω} \times {\vec{v}}_{atom} ) ,$$

where h\vec{k}_{eff} is the momentum imparted the the atom by the MTL beam, and \vec{a} is the interferometer acceleration vector, \vec{Ω} is the interferometer rotation rate vector, and \vec{ν}ₐₜₒₘ is the mean velocity of the atoms. Interferometer phase Φ is inferred from the atomic population in the interferometer output ports. Population can be measured through a variety of state-dependent response means such as state-selective atomic fluorescence. Single interferometers, or multiple interferometers, can thus be arranged to provide measurements of accelerations, rotation rates, gravitational accelerations, gravity gradients, or other inertial effects.

The block schematic in FIG. 1 illustrates an exemplary case of such MTL-based atom interferometers. As illustrated in FIG. 1, in such interferometers, a first MTL beam provides a π/2 pulse to each atom traveling in the atom beam through the interferometer, operating analogously to a beamsplitter in optical interferometry. The π/2 pulse causes the atom to propagate in a quantum superposition of two different momenta, which are separated by the photon recoil momentum h\vec{k}_{eff}. Following a free evolution period T, a second MTL beam provides a π pulse to each atom, operating analogously to a mirror in optical interferometry. The π pulse causes the momenta in the two different atomic trajectories to exchange places as illustrated in FIG. 1. Following a second free evolution period T, a third MTL beam provides a π/2 pulse to each atom, recombining the two atomic trajectories and causing interference between the two superposed atomic trajectories to occur. The population of atoms exiting the interferometer in each of two output ports depends on the phase difference Φ between the two interfering atomic trajectories in the interferometer.

Atom-interferometric inertial sensors rely on sources of either hot or cold atomic gases within vacuum cells. Hot atom sources include vapor cells near room temperature or higher, or atom beams emitted from ovens, and have root-mean-square atomic velocities of hundreds of meters per second. Cold atoms are generated from hot atomic vapors by laser cooling and/or trapping. Common examples of cold atom sources include 3D magneto-optical traps and 3D optical molasses, both of which cool atoms in three dimensions and typically cool atoms to root-mean-square atomic velocities of centimeters per second. See Metcalf and Van der Straten, “Laser cooling and trapping of neutral atoms,” The Optics Encyclopedia: Basic Foundations and Practical Applications (2007); see also U.S. Patent Application Publication No. 2021/0243877A1 to Black et al., entitled “Continuous, Velocity-Controlled Three-Dimensionally Laser-Cooled Atom Beam Source with Low Fluorescence.” Some atom sources are partially cooled, such as 2D magneto-optical traps that trap and cool atoms in two dimensions but do not cool in the third dimension. See J. Schoser et al., “Intense source of cold Rb atoms from a pure two-dimensional magneto-optical trap,” Phys. Rev. A 66, 023410 (2002).

Atom interferometers based on hot, continuously emitted atom beams are able to measure continuously and with high bandwidth by addressing the continuous stream of atoms using lasers. However, the large spread in atomic velocity inherent in hot atom sources reduces measurement sensitivity by a number of mechanisms. For example, interference fringe visibility (or contrast) is reduced because of Doppler shifts and inhomogeneous coupling to atoms due to their finite velocity distribution. The total free evolution time 2T allowed in hot atom beam sources is typically short because of the high mean atomic velocity and high atomic expansion rate. The large distribution of atomic velocities can also create unwanted errors, thereby reducing measurement sensitivity and accuracy. These errors are particularly significant in the presence of dynamic effects such as accelerations and rotations.

Laser cooling of atoms employs a set of laser beams tuned near to an atomic resonance frequency to narrow the velocity distribution of the atoms. See Metcalf and Van der Straten, supra. Additionally, trapping induced by laser beams, magnetic fields, or both can reduce the size of the atomic position distribution. Three-dimensionally laser-cooled atomic samples, particularly atomic samples cooled well below the Doppler limit in three dimensions (“3D ultracold atoms”), can provide better sensitivity and stability in atom interferometer inertial sensors compared with hot atoms. See F. A. Narducci, et al., “Advances toward fieldable atom interferometers,” Advances in Physics: X 7.1 (2022): 1946426.

In most prior art methods employing 3D ultracold atoms, atom interferometry has been performed by pulsed techniques, in which a single measurement cycle consists of a cooling and/or trapping period, followed by a measurement period in which the cooled atoms undergo an interference and measurement sequence. See Narducci et al., supra.

However, such pulsed, rather than continuous, operation of cold-atom interferometers leads to the significant drawbacks. For example, measurement bandwidth is reduced due to the limitations of time needed to cool the atoms. In addition, “dead time” in such pulsed operation-periods within the measurement cycle when no measurement occurs-leads to a reduction in signal-to-noise ratio due to aliasing of signals and noise sources, and thus to errors in estimation of position and attitude in inertial measurement systems based on atom interferometry.

Some prior art has addressed the dead time and bandwidth deficiencies of cold-atom sources by operating in a “zero-dead-time” mode in which the periodic process of cooling and/or trapping of atoms occurs in one spatial region of the vacuum system while measurement takes place simultaneously on a previously prepared ensemble of atoms in a nearby region. See U.S. Pat. No. 7,317,184 to Kasevich et al., entitled “Kinematic Sensors Employing Atom Interferometer Phases” and U.S. Pat. No. 9,019,506 to Black et al., entitled “Phase Control for Dual Atom Interferometers.” See also D. Savoie et al., “Interleaved atom interferometry for high-sensitivity inertial measurements,” Science Advances 4.12 (2018).

However, this past approach suffers from the deficiency that the rescatter of near-resonant cooling light from the cooling region into the measurement region can eliminate the quantum superposition that atomic clocks, interferometers and sensors rely upon for operation. See J. P. Davis et al, “Raman spectroscopy in the presence of stray resonant light,” Appl. Opt. 55, C39 (2016). This method can be effective for stationary platforms if the ballistic flight of the atoms is of long enough duration to impart significant curvature of the atomic trajectory due to gravity, allowing optical baffles to block the near-resonant cooling light from the measurement region. If such predictable trajectory curvature is not possible due to size or dynamics constraints, however, then the near-resonant cooling light from the cooling region will scatter from the atoms in the measurement region and degrade interferometer performance. Because the intensity of scattered light falls of as the inverse square of the distance, this degradation is most significant in atom interferometers that are small in size.

In some prior art, partial laser cooling has been employed in continuous atomic beams used for atom interferometry. For example, two-dimensional cooling of the transverse degree of freedom has been employed. See T. L. Gustavson, et al., “Precision rotation measurements with an atom interferometer gyroscope,” Physical Review Letters 78.11 (1997), 2046. An imbalanced three-dimensional trap has been used as a source of a continuous atomic beam for atom interferometry, with a longitudinal velocity width of a few meters/second. See Hongbo Xue et al., “A continuous cold atomic beam interferometer,” Journal of Applied Physics 117.9 (2015): 094901. However, no prior art has demonstrated a continuously measuring atomic beam interferometer featuring atoms cooled to ultracold temperatures (significantly below the Doppler limit) along all three dimensions.

In some prior art, spatially separated normalized detection has been employed. See G. W. Biedermann et al, “Low-noise simultaneous fluorescence detection of two atomic states,” Optics Letters 34, 347 (2009). In this method of state detection, a near-resonance laser beam (“push beam”) applies a state-selective force to the atoms, spatially separating two different stable atomic states. Readout of the populations of these two states then takes place simultaneously using one or more laser beams (“detection beam”) that induce a spatially resolved response, e.g., a fluorescence response, in both spatially separated atomic samples. Individual measurement of each state population reduces noise in measurement of interferometer phase deriving from fluctuations in the total atomic flux, from detection beam intensity, and from frequency noise. See J. Rudolph et al., “Large momentum transfer clock atom interferometry on the 689 nm intercombination line of strontium,” Physical Review Letters 124.8 (2020): 083604.

In some prior art atom interferometers, periodic or occasional reversal of the direction of inertial sensitivity of the interferometer (“case reversal” or “k-reversal” in the literature) is employed. See D. S. Durfee et al, “Long-Term Stability of an Area-Reversible Atom-Interferometer Sagnac Gyroscope,” Phys. Rev. Lett. 97, 240801 (2006). The advantage of this mode of operation is the suppression of errors through combination of phase measurements made with opposite sign of inertial sensitivity.

Case reversal has been implemented in both pulsed and continuous-beam atom interferometers, and takes place through reversal of the direction of photon recoil imparted by the MTL beams, which is caused to occur by altering the propagation direction or frequency content of the MTL beams. Because of the finite case reversal rate f_{R}, time-dependent errors with temporal frequency f>f_{R}/2 are not suppressed by this method. In all prior art, the case reversal takes place at a rate f_{R}≤1/T, where T is the free-evolution time of the interferometer. See, e.g., Alexandre Gauguet et al., “Characterization and limits of a cold-atom Sagnac interferometer,” Physical Review A 80.6 (2009): 063604; J. M. McGuirk et al., “Sensitive absolute-gravity gradiometry using atom interferometry,” Phys. Rev. A 65, 033608 (2002); and A. Louchet-Chauvet et al., “The influence of transverse motion within an atomic gravimeter,” New J. Phys. 13, 065025 (2011). The frequency band in which errors have been suppressed by case reversal is thus limited to ≤½T, and there is no suppression of errors occurring faster than this rate.

Also in some prior art, operation of atom interferometers at multiple scale factors (“composite-fringe interferometry”) has been employed to increase dynamic range. See C. Avinadav et al, “Composite-Fringe Atom Interferometry for High-Dynamic-Range Sensing,” Phys. Rev. Applied 13, 054053 (2020). This operational mode overcomes dynamic range limitations by creating an unambiguous one-to-one relationship between measured interferometer phases and accelerations or rotation rates.

In some prior art, multiple scale factor operation has been achieved by varying the timing of timed MTL pulses. Prior art has only concerned the implementation of multi-scale-factor operation in pulsed, rather than continuous-beam, cold-atom interferometers. Pulsed cold-atom interferometers, as described earlier, suffer from drawbacks in bandwidth and dead time, which are resolved through continuous measurement in atomic beams.

In other prior art, atom interferometer readout through “phase shear” has been demonstrated. See A. Sugarbaker et al, “Enhanced Atom Interferometer Readout through the Application of Phase Shear,” Phys. Rev. Lett. 11, 113002. This method can be used in conjunction with, or instead of, spatially normalized detection (described above). In this method, the propagation angle of one or more MTL beams is adjusted to produce a spatially dependent interferometer phase. The output atomic state is thereby spatially modulated. Spatially resolved imaging of state-dependent atomic fluorescence therefore reveals dark and bright bands in the fluorescence pattern, from which both fringe amplitude and fringe phase may be determined through methods such as curve fitting, Fourier transformation, or principal component analysis. The prior art has only been concerned with the implementation of phase shear readout in pulsed, rather than continuous-beam, cold-atom interferometers. In such cases, phase shear readout has been implemented through a time-varying angle in the direction of an MTL beam, and has taken place at a measurement rate much slower than 1/T.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention overcomes the disadvantages of the prior art by providing an atom interferometer that utilizes a continuous 3D-cooled atom beam as its basis, in a design that does not rely upon long-T parabolic trajectories to exclude the effects of scattered light.

### BRIEF DESCRIPTION OF THE DRAWINGS

FIG. 1 is a block schematic illustrating aspects of an exemplary atom interferometer in accordance with the prior art.

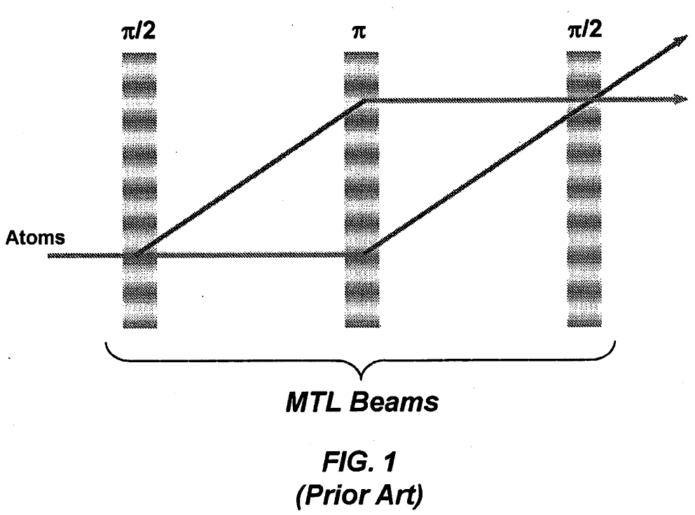

FIG. 2 is a block schematic illustrating aspects of an atom interferometer in accordance with one or more aspects of the present disclosure.

FIGS. 3A-3B are block schematic illustrating aspects of an exemplary embodiment of case reversal in a continuous atom interferometer in accordance with one or more aspects of the present disclosure.

FIGS. 4A-4B are block schematics illustrating aspects of another exemplary embodiment of case reversal in a continuous atom interferometer in accordance with one or more aspects of the present disclosure.

FIG. 5 is a plot of a time series of interferometer fluorescence data with case reversal implemented in accordance with the present invention at an exemplary case reversal rate f_{R} of 488 Hz, or 3/T.

FIGS. 6A-6C illustrate aspects of an exemplary phase-shear fringe readout at a rate of 160 Hz in accordance with the present invention.

FIGS. 7A and 7B illustrate aspects of a continuous spatially separated normalized state detection in an interferometer using a 3D-cooled atom beam in accordance with the present invention.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The present invention overcomes the disadvantages of the prior art by providing an atom interferometer that utilizes a continuous 3D-cooled atom beam as its basis in a design that does not rely upon long-T parabolic trajectories to exclude the effects of scattered light. As described in more detail below, the use of such a continuous 3D-cooled atom beam provides significant improvements over the prior art.

The present invention is the first application of spatially normalized state detection to continuous-beam interferometers. This method is less effective in the predominant methods of continuous-beam interferometry in the prior art because the large mean atomic velocity and large velocity spread makes the pushing and detection process impractical. The use of a continuous 3D-cooled atom beam in accordance with the present invention provides a slow and narrow velocity distribution and precisely controlled mean velocity (compared with prior art of continuous atom beams), which combine to make it practical to achieve a high degree of separation of atomic states.

The accurate, real-time atom velocity control enabled by the use of an ultracold atom beam in accordance with the present invention makes possible rapid variation in the interferometer scale factor, with measurements made using different atomic velocities allowing implementation of composite-fringe interferometry techniques in the continuous beam.

The use of a continuous 3D-cooled atom beam in accordance with the present invention also enables case reversal of the atom interferometer to be performed at a rate f_{R}>1/T, where Tis the free-evolution time of the atom interferometer, resulting in a much higher bandwidth of error suppression than is possible using prior art interferometers. In many implementations, this free-evolution time is the time needed for the atoms to transit between adjacent Raman pulses, but in other implementations, the free-evolution time may differ. Case reversal at slower rates remains possible as well.

The present invention improves upon the state-of-the-art by providing phase shear readout in the continuous atomic beam at a rate >1/T. Additionally, in the present invention, phase shear readout is provided by a steady-state change in the angle of one MTL beam, rather than requiring time-dependent actuation of MTL beam angle as in prior art.

These and other aspects of the present invention can be implemented using the apparatus and method described below in the context of one or more embodiments illustrated in the FIGURES which form a part of the present disclosure.

Although a continuous 3D-cooled atom interferometer in accordance with the present invention can be implemented using a single atom beam, in many cases, it is implemented as a dual-beam interferometer in which counterpropagating atom beams individually measure a combined rotation rate and linear acceleration, while the concurrent measurement of both beams enables distinction between rotation rate and linear acceleration.

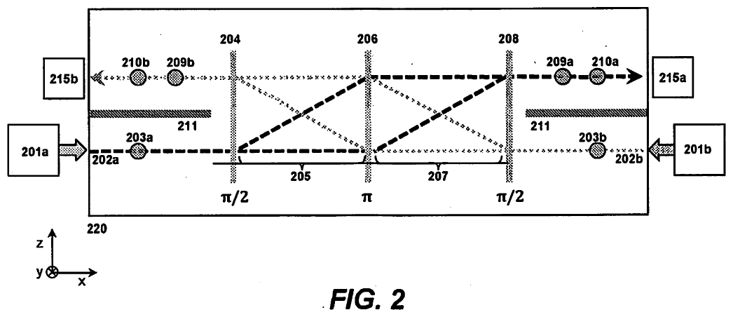

The block schematic in FIG. 2 illustrates an exemplary embodiment of a continuous 3D-cooled dual-beam atom interferometer in accordance with the present invention.

As illustrated in FIG. 2, such a dual-beam interferometer comprises two atom interferometers, denoted in the FIGURE as “a” and “b,” respectively, operating continuously and concurrently. As illustrated in FIG. 2, Each interferometer includes a state preparation region 203a/203b, a set of momentum-transfer laser (MTL) beams 204, 206, and 208 separated by free evolution regions 205 and 207, a state separation region 209a/209b, and a fluorescence detection region 210a/210b. A single vacuum system 220 operating a high or ultra-high vacuum encloses all of these elements to form a single unit. Cold-atom beam source 201a/201b provide continuous beams 202a/202b of 3D-cooled atoms having a temperature less than 100 μK in all three dimensions and having a controllable velocity to the interferometers, with opaque light baffles 211 shielding the atom beam in each interferometer from scattered light produced by laser beams interacting with the other atom beam. A laser and electronic control system (not shown) supplies laser beams and magnetic field control currents to the interferometers and provides signal acquisition and processing.

The exemplary embodiment described here provides an inertial measurement with sensitivity to one-dimensional acceleration and rotation rates. The direction of acceleration sensitivity is equal to the direction of propagation of the coherent interaction laser beams (\vec{k}_{eff}), while the axis of rotation sensitivity is along the direction perpendicular both to the direction of propagation of the coherent interaction laser beams and the direction of propagation of the atomic beams (\vec{k}_{eff}×\vec{ν}ₐₜₒₘ). Accelerations and rotation rates in three dimensions can be measured through the use of three identical dual-atom-beam interferometers, appropriately arranged. In this case, multiple interferometers may share resources such as a vacuum chamber, cooling lasers, or MTL beams.

Cold atom sources 201a/201b produce continuous beams of atoms 202a/202b with high flux and low emission of near-resonance fluorescence light along the atomic trajectory, the atoms having an ultracold (below 100 microKelvin) atomic temperature and an atomic velocity controllable through radio frequencies. See U.S. Patent Application Publication No. 2021/0243877A1, supra; see also J. Kwolek et al., “Three-Dimensional Cooling of an Atom-Beam Source for High-Contrast Atom Interferometry,” Phys. Rev. Applied 13, 044057 (2020). In many embodiments, alkali atoms such as rubidium are used, but alkaline earth atoms or other atomic species may be employed instead.

The cold atom beams 202a/202b are input into vacuum chamber 220 for use in the interferometer.

Each of the cold atom beams is initially directed into its respective state preparation region 203a/203b, in which a laser beam (not shown) optically pumps atoms in the beam to a ground state whose energy is insensitive to magnetic field to first order, with magnetic quantum number m_{F}=0. This can be accomplished through any method familiar to those skilled in the field of atomic physics or related fields. For example, in rubidium-87, application to the atoms of light resonant with the electric dipole transition from the F=1 ground state to the F=0 excited state and with linear polarization perpendicular to an applied magnetic field accomplishes this state preparation task.

As described in more detail below, the optically pumped atoms are subjected to MTL beams in MTL regions 204, 206, and 208, wherein interaction between the atoms and each MTL beam results in a coherent transfer of atomic population between long-lived atomic states, with the momenta of atoms in the different states differing by the photon recoil momentum transferred by the interaction between the atoms and the MTL beams. In an exemplary embodiment, the interaction in the first and last MTL region 204 and 208 is provided by stimulated Raman π/2 pulses, while the interaction in the central MTL region 206 is provided by a stimulated Raman π pulse. In an exemplary embodiment, the MTL beams addressing the two interferometers are the same beams, but this is not a critical element of the invention, and other configurations of the MTL beams may be used.

In the free evolution regions 205 and 207, only a minimal amount of background scattered light is incident on the atoms, such that the influence of the scattered light on the state of the atoms in the beams is negligible.

In an exemplary embodiment in which three pairs of MTL beams produce a sequence of Raman π/2, π, and π/2 pulses, each of the three Raman pulses transfers atomic population between two atomic states, while at the same time transferring atomic population between two momentum states. The first coherent π/2 pulse in MTL region 204 creates a quantum superposition of atomic states, with the momentum separation between the two states equal to the two-photon recoil momentum. A free evolution time T follows, during which the two atomic states separate spatially due to their momentum difference. The coherent x pulse in MTL region 206 swaps the atomic population between the two atomic states and trajectories, while transferring a two-photon recoil momentum such that the two trajectories move closer together during the ensuing free evolution time T. The final coherent π/2 pulse in MTL region 208 causes the two trajectories to interfere.

The combination of the interactions in the coherent interaction regions and the free evolution region results in an atomic interference signal from each atom beam, in which the phase difference between the two interferometer arms determines the occupancy of the atomic states at the interferometer outputs. In the presence of rotations, accelerations, or gravity, the interferometer phase depends approximately linearly on acceleration and rotation rate.

As described in more detail below, the two atomic states for each atom beam in the interferometer are spatially separated from one another in state separation regions 209a/209b by means of interaction with a near-resonance “push” beam (not shown) that applies radiation pressure to one atomic state but not the other atomic state for each atom in the beam. During free flight between the state separation regions and the detection regions 210a/210b for the two atom beams, the atomic states separate with constant velocity.

In the detection regions 210a/210b of an atom interferometer in accordance with the present invention, a near-resonant laser beam, combined with a repumper beam, induces a state-dependent response, e.g., a state-dependent optical fluorescence, optical absorption, or ionization, in both spatially separated sets of atoms. The thus-induced response from each atom beam is detected by a detector 215a/215b located within or outside of the vacuum enclosure 220, and provides a measurement of the relative occupancy of the two atomic states. Detector 215a/215b can be any suitable detector that can measure (individually or differentially) the response, e.g., the optical fluorescence, from the two spatially separated atomic states, such as a segmented photodetector, a set of photodetectors, or a camera. In the case of phase shear imaging, the spatially resolved image of fringes on a camera is recorded, or a projection of the image onto sinusoidal patterns may be measured through the use of intensity masks and photodetectors.

The signals from detectors 215a/215b are then sent to a processor (e.g., a computer, microcontroller, FPGA, or ASIC) that calculates, based on the photodiode signals, the phase of each interferometer. The acceleration, rotation rate, or other measurement quantities of interest are then computed and sent to an appropriate output.

As noted above, in many cases, case reversal of the atom beams in the interferometer, i.e., reversal of the direction of photon recoil imparted by the MTL beams, is employed to suppress errors through subtraction of phase measurements made with opposite sign of inertial sensitivity. Such case reversal is produced by altering the propagation direction or frequency content of the MTL beams at a rate f_{R}.

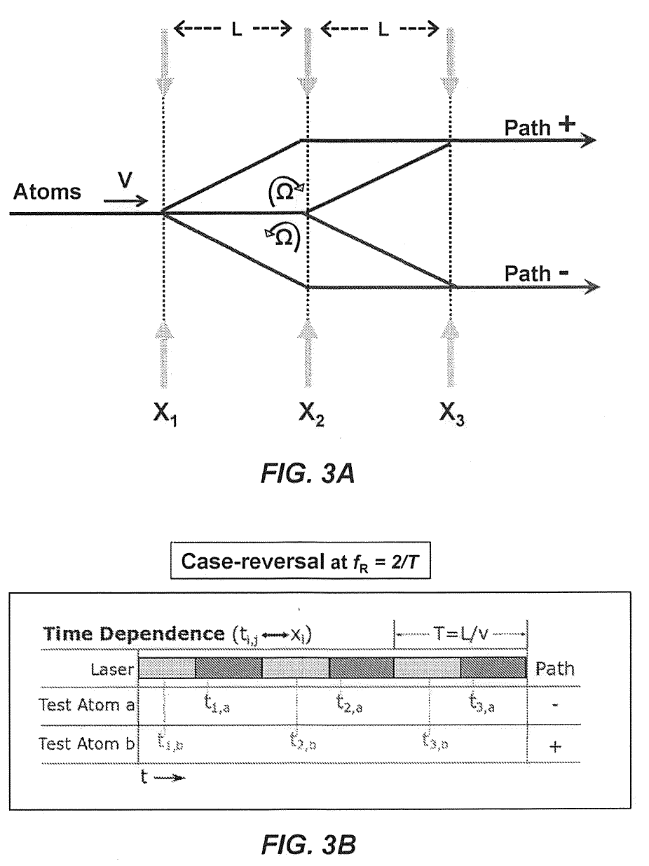

As illustrated by the block schematic in FIG. 3A, in some embodiments of an atom interferometer in accordance with the present invention, case reversal is implemented by periodically switching the MTL beams between two configurations at a predetermined reversal rate f_{R}, where all three MTL regions X₁, X₂, and X₃ have a first common photon recoil direction, denoted “+ + +” in the first configuration and all three MTL regions X₁, X₂, and X₃ have the opposite photon recoil direction, denoted “− − −,” in the second configuration.

As illustrated in FIG. 3A, atoms move from left to right through the interferometer at velocity v, while the MTL regions are separated by distance L, such that T=L/v. Each atom that interacts with all three MTL regions in the “+” configuration follows the upper pair of interfering trajectories labeled “Path +,” and each atom that interacts with the three MTL beams in the “−” configuration follows the lower pair of interfering trajectories labeled “Path −.” Path + and Path − have opposite sensitivity to rotation rate Ω and acceleration. Any atom that interacts with a set of MTL beams that do not all have the same direction of photon recoil—for example, if X₁ has the “+” direction while X₂ and X₃ both have the “−” direction − will fail to produce an interference signal.

For case reversal between the “+ + +” and “− − −” MTL photon recoil directions, as illustrated in FIG. 3A, certain values of the reversal rate f_{R} ensure that a nearly continuous interferometer output is achieved, with minimal dead time. If the reversal takes place at a rate f_{R}=2n/T, where n is an integer, a single atom passing through the three MTL beams observes a common photon recoil direction for all three beams. The only exception is a very brief signal dropout occurring for atoms that are within the MTL beams at the time when the recoil direction is switched.

The table in FIG. 3B illustrates the timing of case reversal for some embodiments of an atom interferometer in accordance with the present invention, in the specific example of f_{R}=2/T. In the table in FIG. 3B, time proceeds from left to right, and the timing of the case reversal is indicated in the row labeled “Laser.” The light-grey segments of the Laser row indicate times during which the MTL regions X₁, X₂, and X₃ have photon recoil directions “+ + +,” while the dark-grey segments of the Laser row indicate times during which the MTL regions X₁, X₂, and X₃ have photon recoil directions “− − −” The “Test Atom a” and “Test Atom b” rows show the timing of two example atoms moving through the interferometer at velocity v, which are displaced in space such that their times of interaction with each of the MTL regions differ by an amount smaller than T. Test Atom a interacts with MTL regions X₁, X₂, and X₃ at times t_{1,a}, t_{2,a}, and t_{3,a} respectively, and follows “Path-” illustrated in FIG. 3A, while Test Atom b interacts with MTL regions X₁, X₂, and X₃ at times t_{1,b}, t_{2,b}, and t_{3,b} respectively, and follows “Path +” illustrated in FIG. 3A. As a result, Test Atom a and Test Atom b follow closed interferometer paths with opposite directions of inertial sensitivity.

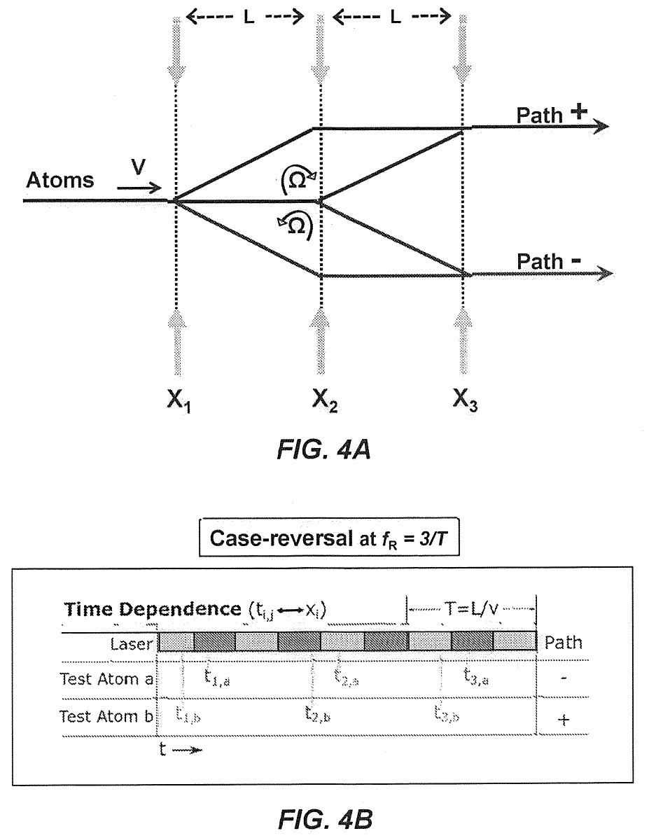

The block schematic in FIG. 4A illustrates aspects of an alternative embodiment of case reversal, where instead of switching between all “+ + +” or “− − −,” the MTL regions periodically switch between a first configuration in which the two outer MTL regions X₁ and X₃ have a common photon recoil direction that is opposite from the central region X₂, e.g., where the MTL regions have “+ − +” directions, and a second configuration in which photon recoil directions are reversed compared to the first configuration, i.e., have “− +−” directions, where the MTL beams are switched between the two configurations at a predetermined reversal rate f_{R}.

For case reversal between the “+ − +” and “− + −” MTL photon recoil directions, as in the embodiment illustrated in FIG. 4A, certain values of the reversal rate f_{R} ensure that a nearly continuous interferometer output is achieved, with minimal dead time. If the reversal takes place at a rate f_{R}=(2n−1) T, where n is a positive integer, a single atom passing through the three MTL regions observes a common photon recoil direction for all three regions. The only exception is a very brief signal dropout occurring for atoms that are within the MTL regions at the time when the recoil direction is switched.

The table in FIG. 4B illustrates the timing of case reversal for some embodiments of an atom interferometer in accordance with the present invention, in the specific example of f_{R}=3/T. In the table in FIG. 4B, time proceeds from left to right, and the timing of the case reversal is indicated in the row labeled “Laser.” The light-grey segments of the Laser row indicate times during which the MTL regions X₁, X₂, and X₃ have photon recoil directions “+ − +,” while the dark-grey segments of the Laser row indicate times during which the MTL regions X₁, X₂, and X₃ have photon recoil directions “− +−.” The “Test Atom a” and “Test Atom b” rows show the timing of two example atoms moving through the interferometer at velocity ν, which are displaced in space such that their times of interaction with each of the MTL regions differ by an amount smaller than T. Test Atom a interacts with MTL regions X₁, X₂, and X₃ at times t_{1,a}, t_{2,a}, and t_{3,a} respectively, and follows “Path −” illustrated in FIG. 4A. Test Atom b interacts with MTL regions X₁, X₂, and X₃ at times t_{1,b}, t_{2,b}, and t_{3,b} respectively, and follows “Path+” illustrated in FIG. 4A. As a result, Test Atom a and Test Atom b follow closed interferometer paths with opposite directions of inertial sensitivity.

The use of the continuous 3D-cooled atom beam makes possible the rapid case reversal with f_{R}>1/T, with a minimum amount of dead time between interferometer outputs with opposite directions of photon recoil. In prior art using non-continuous (pulsed) 3D-cooled atomic samples, the fastest interferometer repetition rate is 1/T. See I. Dutta et al. “Continuous cold-atom inertial sensor with 1 nrad/sec rotation stability,” Physical Review Letters 116.18 (2016): 183003. In pulsed interferometers, the rate of case reversal cannot exceed the interferometer repetition rate.

However, use of a continuous atom beam in the atom interferometer of the present invention provides a continuous output signal, so that case reversal can occur at a rate faster than 1/T provided that the reversal is timed such that closed interferometer trajectories are achieved for nearly all atoms as they propagate through the set of MTL regions. The use of 3D-cooled atoms as in the present invention, in contrast with longitudinally hot atoms in prior art, minimizes the dead time in the case reversal sequence by minimizing the thermal spread in atomic positions that causes overlap of atoms experiencing opposite directions of photon recoil in their interferometer sequences.

Such rapid case reversal in accordance with the present invention is beneficial for the suppression of time-varying systematic errors in the interferometer phase, such as errors due to magnetic fields (quadratic Zeeman shift) or optical fields (ac Stark shift). Such errors may be static, or they may vary in time. For periodic case reversal at a rate f_{R}, only those frequency components of time-varying errors at frequencies below f_{R}/2 are suppressed by case reversal. Errors varying at higher rates may be ineffectively suppressed or aliased to lower frequencies by periodic case reversal. Increasing the rate of case reversal therefore increases the frequency range of time-varying errors that may be suppressed.

To perform phase-shear readout, in some embodiments of an atom interferometer in accordance with the present invention, the angle of one or more of the MTL beams can be altered to produce a photon recoil in one MTL region that is slightly nonparallel to the photon recoil produced in the other MTL regions in the interferometer. In such embodiments, the photon recoil angle should be such that the resulting spatially dependent atom interferometer phase displays at least one interferometer fringe (fluorescence intensity maximum and minimum) in the detection region, without producing so many fringes that they are not visible in detection due to atomic thermal motion or finite spatial resolution of detection. For example, for an atom beam with a diameter of 1 mm and k_{eff}=1.6×10⁷ m⁻¹, a tilt of 60 μrad in the photon recoil direction of a π/2 MTL region results in approximately one complete spatial interference fringe across the atomic beam. As a result, in detection the atomic fluorescence pattern exhibits spatially dependent fringes, the position of which provide a measurement of the phase of the interferometer. These spatial fringes may be imaged at high rate using a camera, and analyzed using automated fitting routines or principal component analysis in a processor. Alternatively, the fringe positions may be read out at higher rate and with a lower processing requirement using a pair of optical intensity masks, each of which transmits either the sine or cosine component of the spatially dependent phase. This readout using intensity masks provides continuous phase shear readout.

To perform composite-fringe measurement, the velocity νₐₜₒₘ of the atomic beams can be modulated, e.g., through control of radio frequencies determining laser frequencies in the cold-atom source's 3D moving optical molasses stage. See U.S. Patent Application Publication No. 2021/0243877A1, supra. Each velocity νₐₜₒₘ corresponds to a different free evolution time T=L/νₐₜₒₘ, where L is the distance separating the MTL beams. The fringe measurements, taken at different velocities and therefore at different scale factors, can be combined to extend the dynamic range of the measurement over a larger range of accelerations and rotation rates.

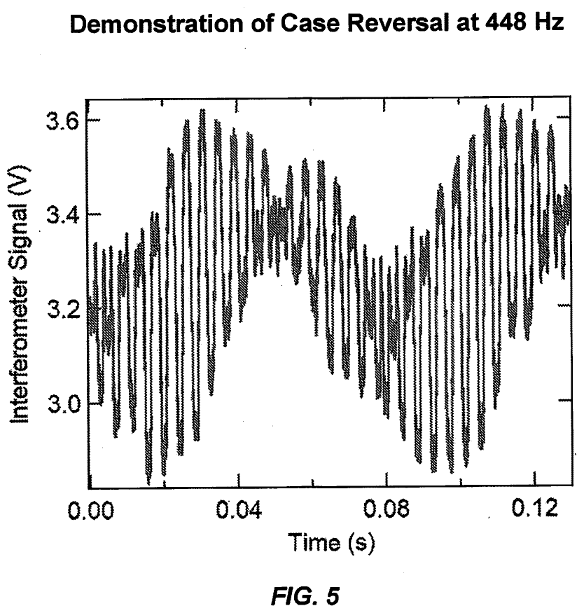

FIG. 5 is a plot of a time series of interferometer fluorescence data with case reversal implemented in accordance with the present invention, at an exemplary rate f_{R}=488 Hz=3/T. The atomic fluorescence signal, which depends on the atom interferometer phase is further modulated at 10 Hz by imposing a difference in frequency of the MTL beams in one MTL region relative to the frequency of the MTL beams in other MTL regions in the interferometer. This slow trace over the full interferometer fringe demonstrates, in this example, the atom interferometer exhibits a different phase and different vertical offset for each of the two directions of photon recoil, which are alternately imposed during case reversal.

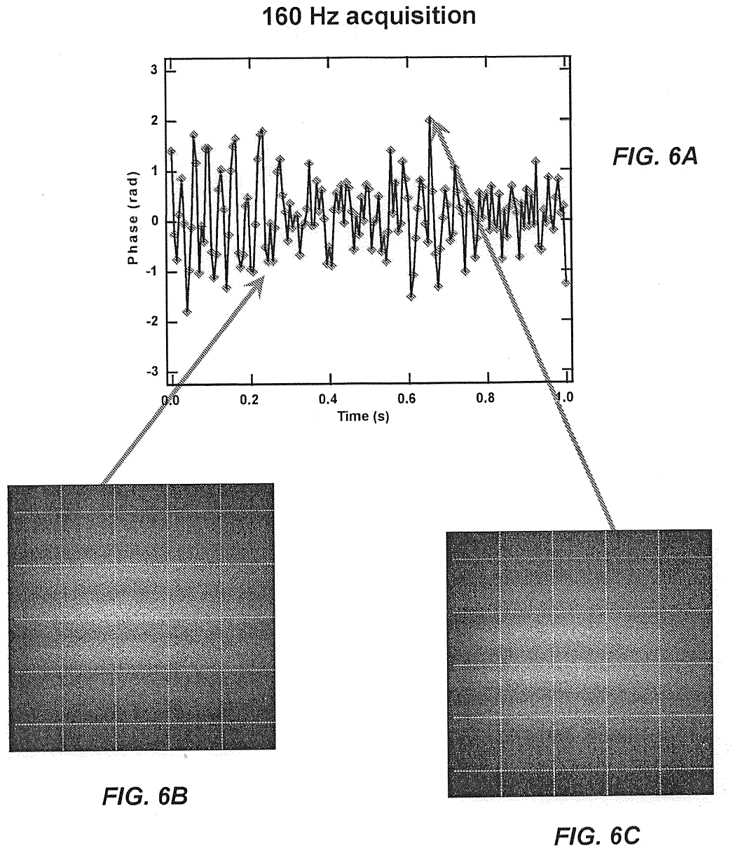

FIGS. 6A-6C are images illustrating phase-shear fringe readout at a rate of 160 Hz in accordance with the present invention.

FIG. 6A is a time series plot of interferometer phases obtained by analysis of atomic fluorescence images acquired at a rate of 160 Hz in the phase-shear mode of continuous atomic beam interferometer operation. This rate is faster than the inverse of the free evolution time of the atom interferometer, i.e., 1/T=149 Hz in this example.

FIGS. 6B and 6C are individual digital camera images displaying exemplary phase-shear fluorescence patterns, representing different interferometer phases. Phase-shear readout provides spatially resolved interference fringes. In contrast with time-resolved interference fringe observation, measurements of fringe amplitude, background levels, and noise levels may be inferred from a single phase-shear measurement using a camera, photodiode array, or mask. In the present invention employing a continuously 3D-cooled atom beam, phase shear readout is possible at a rapid rate, and in particular at a rate faster than 1/T. Continuous 3D cooling improves the spatial contrast in phase shear readout by reducing the “smearing” of atomic positions that occurs due to the velocity distribution of the atomic beam.

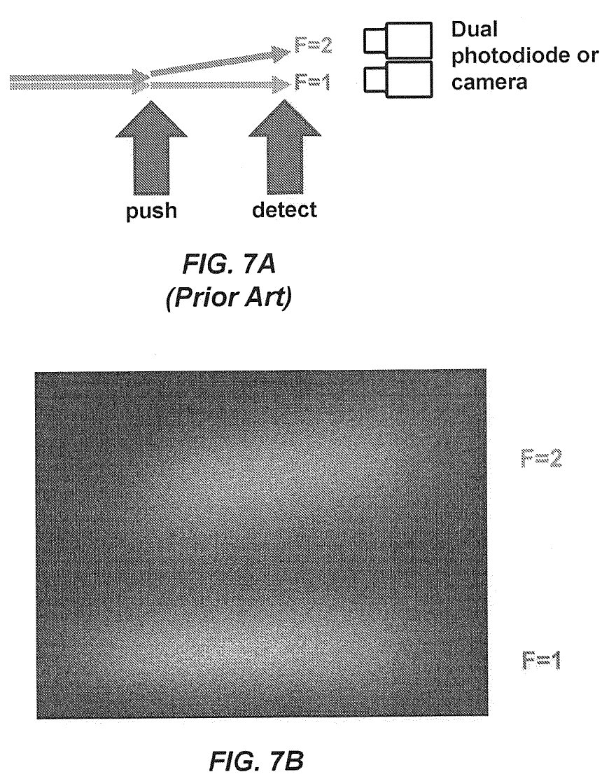

FIGS. 7A-7B illustrate aspects of continuous, spatially separated normalized state detection in a 3D-cooled atom interferometer in accordance with the present invention. Following the atom interferometer MTL sequence, a push laser beam and a detection laser beam interact with the atom beam (FIG. 7A). The push laser beam continuously separates the two interferometer output ports from one another in space, while the detection laser beam induces fluorescence in the spatially separate output ports continuously and simultaneously. A camera image of simultaneous fluorescence in the two output ports of the interferometer is shown in FIG. 7B. The use of simultaneous, spatially separated normalized state detection provides significant benefits in interferometer signal-to-noise ratio and suppression of noise due to fluctuations in laser frequency, laser power, and atom number. See Biedermann et al., supra. In contrast to prior art interferometers, the separation and normalized state detection take place continuously in a 3D-cooled atom interferometer in accordance with the present invention. The use of a 3D-cooled atom beam improves the effectiveness of normalized detection by providing an atom beam with accurately controlled velocity and narrow velocity distribution, which improves the ability of the push laser beam induce a well-resolved and stable spatial separation between the atomic states.

### ADVANTAGES AND NEW FEATURES

A continuous 3D-cooled atom interferometer in accordance with the present invention provides at least the following advantages over interferometers in the prior art:

Continuous atom interferometer fringe measurement using 3D-sub-Doppler-cooled (typically 15 microKelvin or lower) atoms at high flux, providing both high fringe contrast (typically 30%) and high signal-to-noise ratio.

Continuous high-sensitivity acceleration and rotation rate measurement without dead time.

The ability to operate in any orientation with respect to gravity due to continuous cold atomic trajectories that curve, or “sag” by 5 mm or less under the influence of gravity.

Sensor scale factor and measurement bandwidth that are precisely known and dynamically controllable through the precise and accurate control of atomic velocity provided by rf frequency control of the optical molasses used to form the continuous ultracold atom beam.

Ability to perform spatially separated normalized detection in a continuous atomic beam.

Ability to perform composite fringe readout with multiple scale factors in a continuous atomic beam.

Ability to perform high-bandwidth correction of phase errors through rapid reversal of direction of inertial sensing at a rate faster than the inverse interrogation time of the interferometer. Ability to perform high-rate phase shear readout of the phase of the atom interferometer.

### ALTERNATIVES

A continuous 3D-cooled atom interferometer in accordance with the present invention can be implemented using any suitable number and/or arrangements of atom beams.

To suppress propagation of scattered light down the atomic trajectory, an aperture, tube, nozzle, aperture array, microchannel plate, rotary light trap, or other method of blocking scattered light within the atom trajectory to allow atoms to propagate through the interferometer while reducing the propagation of light due to cooling, state preparation, or detection.

To further suppress propagation of scattered light, surfaces in the vacuum cell may be coated with a light-absorbing coating or made from light-absorbing materials.

More than two atom-cooling stages may be used including additional optical molasses stages with different optical intensities or frequencies or Raman sideband cooling stages to further reduce the atomic velocity distribution.

A moving optical lattice stage may be introduced following the cooling region to transport atoms along a desired trajectory at a desired velocity.

While the preferred embodiment depicts two counterpropagating interferometers to provide single-axis acceleration and rotation rate outputs, the invention may be operated with only one interferometer, or with more than two interferometers.

The laser beams may be introduced into the vacuum cell via optical waveguides, optical fibers, or windows.

A magnetic shield may be placed around all or part of the atom beam source, around any part of the device, or around the entire device.

A bias magnetic field may be applied along the direction of MTL beam propagation or along a different direction.

The MTL beams may be frequency modulated to provide lock-in detection of the interferometer phase.

The MTL beams may be frequency and/or phase controlled to compensate for Doppler shifts or motion-induced interferometer phase.

The MTL beams may drive Raman transitions, Bragg transitions, Bloch oscillations, optical lattice transport, or any other type of coherent momentum-changing operation.

The MTL beams may be retro-reflected from a mirror, corner-cube, or other type of retroreflector.

The MTL beams may be routed using a racetrack configuration rather than a retro-reflection configuration.

Counter-propagating MTL beam paths may be provided by insertion of two laser beams that are made phase stable relative to one another using a phase lock.

The interferometer may be coupled to another sensor or sensors including a gyroscope, accelerometer, seismometer, tilt-meter, or gravimeter, to increase bandwidth, extend dynamic range, or provide control signals for the MTL beam frequency and phase.

The MTL beam alignment may be actuated to compensate for accelerations and rotations.

Thus, as described herein, the apparatus and method of the present invention provide the first atom interferometer inertial sensor to combine continuous measurement, high flux of ultracold atoms, high interference fringe contrast, and the ability to operate in any orientation relative to the direction of gravity. Additionally, it is the first atom interferometer to perform sub-interrogation-time case reversal. Finally, it is the first atom interferometer to perform spatially separated normalized detection, phase shear readout, or composite-fringe interferometry in a continuous atomic beam.

Although particular embodiments, aspects, and features have been described and illustrated, one skilled in the art would readily appreciate that the invention described herein is not limited to only those embodiments, aspects, and features but also contemplates any and all modifications and alternative embodiments that are within the spirit and scope of the underlying invention described and claimed herein. The present application contemplates any and all modifications within the spirit and scope of the underlying invention described and claimed herein, and all such modifications and alternative embodiments are deemed to be within the scope and spirit of the present disclosure.

1. An atom beam interferometer comprising:
an atom beam source configured to direct an atom beam of three-dimensionally cooled atoms having a temperature less than 100 microKelvin (μK) in all three dimensions and having a controllable velocity into a vacuum chamber, the atoms in the atom beam being optically pumped when they enter the vacuum chamber;
a plurality of momentum transfer laser (MTL) beam sources configured to direct a set of spaced-apart MTL beams to a plurality of spatially separated MTL regions within the atom beam, so that within each MTL region the MTL beams coherently impart photon recoil momenta to the atoms of the atom beam, with the MTL beams configured to produce an interference signal in the atom beam, wherein the MTL beam sources are configured to alternatingly switch the MTL beams between a first case to provide a first interfering trajectory path for the atom beam and a second case to provide a second interfering trajectory path for the atom beam, wherein the atom beam source is configured to continuously direct the atom beam through the MTL regions while the MTL beams are switched between the first and second cases;
a detection region at an end of the vacuum chamber, wherein the detection region is configured to receive atoms from the atom beam along the first interfering trajectory path and the second interfering trajectory path and to induce a state-dependent response from the atoms of the atom beam as the atom beam passes through the detection region, the responses of the atoms of the atom beam providing data of atomic states occupied by the atoms, the atomic states of the atoms being determined by respective interactions between the atoms of the atom beam and the MTL beams incident on the atoms of the atom beam, wherein the first interfering trajectory path for the atom beam and the second interfering trajectory path for the atom beam are different; and a processor coupled to the detection region, wherein the processor is configured to receive the data of the atomic states and to translate the data into data of a measurement to be output from the interferometer.

2. The atom beam interferometer according to claim 1, wherein a case-reversal rate f_{R} between the first and second cases is an integer multiple of 1/T, where Tis a transit time of the atoms between an adjacent pair of the MTL regions.

3. The atom beam interferometer according to claim 1, wherein the data of the atomic states occupied by the atoms is provided based on the first interfering trajectory path from the first case and the second interfering trajectory path from the second case, and wherein the measurement is based on the first interfering trajectory path from the first case and the second interfering trajectory path from the second case.

4. The atom beam interferometer according to claim 1, wherein the atom beam source is a first atom beam source, wherein the atom beam is a first atom beam, wherein the detection region is a first detection region, and wherein the atom beam interferometer further comprises:
a second atom beam source configured to direct a second atom beam of three-dimensionally cooled atoms into the vacuum chamber, wherein the first and second atom beams propagate through the MTL beams in opposite directions; and
a second detection region that is configured to provide data of atomic states of atoms of the second atom beam;
wherein the processor is coupled with the second detection region, and wherein the processor is configured to receive the data of the atomic states of the atoms of the second atom beam and to translate the data of the atomic states of the atoms of the second atom beam into data of a measurement to be output from the interferometer.

5. The atom beam interferometer according to claim 1, wherein the MTL beam sources are arranged so that the MTL beams alternately produce a first photon recoil direction and a second photon recoil direction different than the first photon recoil direction as the atom beam traverses the MTL regions, wherein the first photon recoil direction produces a first direction of inertial sensitivity corresponding to the first case and the second photon recoil direction produces a second direction of inertial sensitivity different than the first direction of inertial sensitivity and corresponding to the second case;
wherein each MTL region implements a photon recoil direction that is the same as the photon recoil direction implemented by its adjacent MTL region or regions, and each MTL region alternates in photon recoil directions corresponding to each case, with all MTL regions switching case at substantially the same time; and
wherein a case-reversal rate f_{R} between the first and second cases is an even multiple of 1/T, where T is a transit time of the atoms between an adjacent pair of the MTL regions.

6. The atom beam interferometer according to claim 1, wherein the MTL beam sources are arranged so that the MTL beams alternately produce a first photon recoil direction and a second photon recoil direction different than the first photon recoil direction as the atom beam traverses the MTL regions, wherein the first photon recoil direction produces a first direction of inertial sensitivity corresponding to the first case and the second photon recoil direction produces a second direction of inertial sensitivity different than the first photon recoil direction and corresponding to the second case; and
wherein each MTL region implements a photon recoil direction that is different than the photon recoil direction implemented by its adjacent MTL region or regions, and each MTL region alternates in photon recoil directions corresponding to each case, with all MTL regions switching case at substantially the same time; and
wherein in each MTL region, a case-reversal rate f_{R} between the first and second cases is an odd multiple of 1/T, where Tis a transit time of the atoms between an adjacent pair of MTL regions.

7. The atom beam interferometer according to claim 1, wherein a direction of photon recoil produced by the set of MTL beams in at least one MTL region has a nonparallel angular deviation with respect to a direction of photon recoil provided by MTL beams in other MTL regions;
wherein a spatially dependent atom interferometer fringe produced by the nonparallel angular deviation in at least one MTL region is measured through a spatially-resolved detection of the atomic state;
wherein a measurement of the fringe pattern occurs at a rate greater than 1/T, where Tis a transit time of the atoms between an adjacent pair of MTL regions.

8. The atom beam interferometer according to claim 1, wherein the velocity of the atoms is controlled to vary according to a sequence.

9. An atom beam interferometer comprising:
an atom beam source configured to provide an atom beam having three-dimensionally cooled atoms with a temperature of less than 100 microKelvin (μK) in all three dimensions;
a plurality of momentum transfer laser (MTL) beam sources that direct a set of spaced-apart MTL beams to a plurality of spatially separated MTL regions along the atom beam, so that within each MTL region the MTL beams coherently impart photon recoil momenta to atoms of the atom beam, with the MTL beams being configured to produce an interference signal in the atom beam, wherein the MTL beam sources are configured to alternatingly switch the MTL beams between a first case to provide a first interfering trajectory path for the atom beam and a second case to provide a second interfering trajectory path for the atom beam, wherein the first interfering trajectory path for the atom beam and the second interfering trajectory path for the atom beam are different, and wherein the atom beam source is configured to continuously direct the atom beam through the MTL regions while the MTL beams are switched between the first and second cases;
a detection region configured to receive atoms from the atom beam along the first interfering trajectory path and the second interfering trajectory path and to induce state-dependent responses from the atoms of the atom beam, the state dependent responses of the atoms of the atom beam providing data of atomic states occupied by the atoms; and
a processor coupled to the detection region, wherein the processor is configured to receive the data of the atomic states and to translate the data of the atomic states into a measurement to be output from the interferometer.

10. The atom beam interferometer according to claim 9, wherein a case-reversal rate f_{R} between the first and second cases is an integer multiple of 1/T, where Tis a transit time of the atoms between an adjacent pair of the MTL regions.

11. The atom beam interferometer according to claim 9, wherein the data of the atomic states occupied by the atoms is provided based on the first interfering trajectory path from the first case and the second interfering trajectory path from the second case, and wherein the measurement is based on the first interfering trajectory path from the first case and the second interfering trajectory path from the second case.

12. The atom beam interferometer according to claim 9,
wherein the plurality of MTL beam sources includes first, second, and third MTL beam sources that are configured to direct respective first, second, and third MTL beams to respective first, second, and third MTL regions with the second MTL region between the first and second MTL regions,
wherein the first and third MTL regions provide a first photon recoil direction to the atoms of the atom beam in the first case and the second MTL region provides a second photon recoil direction to the atoms of the atom beam in the first case, wherein the first and second photon recoil directions are different, and
wherein the first and third MTL regions provide the second photon recoil direction to the atoms of the atom beam in the second case and the second MTL region provides the first photon recoil direction to the atoms of the atom beam in the second case.

13. The atom beam interferometer according to claim 12, wherein a transit time of the atoms of the atom beam between the first and second MTL regions and a transmit time of the atoms of the atom beam between the second and third MTL regions are the same, and wherein a case-reversal rate between the first and second cases is an odd multiple of the inverse of the transit time.

14. The atom beam interferometer according to claim 9,
wherein the plurality of MTL beam sources includes first, second, and third MTL beam sources that are configured to direct respective first, second, and third MTL beams to respective first, second, and third MTL regions with the second MTL region between the first and second MTL regions,
wherein the first, second, and third MTL regions provide a first photon recoil direction to the atoms of the atom beam in the first case, and
wherein the first, second, and third MTL regions provide a second photon recoil direction to the atoms of the atom beam in the second case, and wherein the first and second photon recoil directions are different.

15. The atom beam interferometer according to claim 14, wherein a transit time of the atoms of the atom beam between the first and second MTL regions and a transmit time of the atoms of the atom beam between the second and third MTL regions are the same, and wherein a case-reversal rate between the first and second cases is an even multiple of the inverse of the transit time.

16. The atom beam interferometer according to claim 9, wherein the atom beam source is configured to modulate a velocity of the atoms of the atom beam.

17. The atom beam interferometer according to claim 9, wherein one of the MTL beam sources is configured to impose a difference in frequency of the respective MTL beam in one MTL region relative to another one of the MTL beams in another one of the MTL regions.

18. A method providing atom beam interferometry, the method comprising:
providing an atom beam having three-dimensionally cooled atoms with a temperature of less than 100 microKelvin (μk) in all three dimensions;
directing a set of spaced-apart MTL beams to a plurality of spatially separated MTL regions along the atom beam, so that within each MTL region the MTL beams coherently impart photon recoil momenta to atoms of the atom beam to produce an interference signal in the atom beam, wherein the MTL beams are alternatingly switched between a first case to provide a first interfering trajectory path for the atom beam and a second case to provide a second interfering trajectory path for the atom beam, wherein the first interfering trajectory path for the atom beam and the second interfering trajectory path for the atom beam are different, and wherein the atom beam is continuously directed through the MTL regions while the MTL beams are switched between the first and second cases;
receiving atoms from the atom beam along the first interfering trajectory path and the second interfering trajectory path at a detection region;
inducing state-dependent responses from the atoms of the atom beam in the detection region, wherein the state dependent responses of the atoms of the atom beam provide data of atomic states occupied by the atoms; and
translating the data of the atomic states into an interferometry measurement.

19. The method according to claim 18, wherein a case-reversal rate f_{R} between the first and second cases is an integer multiple of 1/T, where Tis a transit time of the atoms between an adjacent pair of the MTL regions.

20. The method according to claim 18, wherein the data of the atomic states occupied by the atoms is provided based on the first interfering trajectory path from the first case and the second interfering trajectory path from the second case, and wherein the measurement is based on the first interfering trajectory path from the first case and the second interfering trajectory path from the second case.

21. The method according to claim 18,
wherein the plurality of MTL beams includes first, second, and third MTL beams that are directed to respective first, second, and third MTL regions with the second MTL region between the first and second MTL regions,
wherein the first and third MTL regions provide a first photon recoil direction to the atoms of the atom beam in the first case and the second MTL region provides a second photon recoil direction to the atoms of the atom beam in the first case, wherein the first and second photon recoil directions are different, and
wherein the first and third MTL regions provide the second photon recoil direction to the atoms of the atom beam in the second case and the second MTL region provides the first photon recoil direction to the atoms of the atom beam in the second case.

22. The method according to claim 21, wherein a transit time of the atoms of the atom beam between the first and second MTL regions and a transmit time of the atoms of the atom beam between the second and third MTL regions are the same, and wherein a case-reversal rate between the first and second cases is an odd multiple of an inverse of the transit time.

23. The method according to claim 18,
wherein the plurality of MTL beams includes first, second, and third MTL beams that are directed to respective first, second, and third MTL regions with the second MTL region between the first and second MTL regions,
wherein the first, second, and third MTL regions provide a first photon recoil direction to the atoms of the atom beam in the first case, and
wherein the first, second, and third MTL regions provide the second photon recoil direction to the atoms of the atom beam in the second case.

24. The method according to claim 23, wherein a transit time of the atoms of the atom beam between the first and second MTL regions and a transmit time of the atoms of the atom beam between the second and third MTL regions are the same, and wherein a case-reversal rate between the first and second cases is an even multiple of an inverse of the transit time.
